(19) United States
(12) Patent Application Publication
(10) Pub. No.: US 2012/0001852 A1
(43) Pub. Date: Jan. 5, 2012

(54) COMPUTER KEYBOARD HAVING DETACHABLE MULTI-FUNCTIONAL TOUCHPAD

(75) Inventors: Chien-Ming Ho, Taipei (TW); Hung-Ming Lin, Taipei (TW)

(73) Assignee: PRIMAX ELECTRONICS LTD., Taipei (TW)

(21) Appl. No.: 12/844,364

(22) Filed: Jul. 27, 2010

(30) Foreign Application Priority Data
Jun. 30, 2010 (TW) 099121397

(51) Int. Cl. G06F 3/02

(52) U.S. Cl. 345/168

(57) ABSTRACT

A computer keyboard has a detachable multi-functional touchpad. The computer keyboard is in communication with a computer host. The computer keyboard includes a keyboard body and a multi-functional touchpad. In a first usage status where the multi-functional touchpad is connected with the keyboard body, an image of a numeric keypad is shown. In a second usage status where the multi-functional touchpad is detached from the keyboard body, the multi-functional touchpad functions as a multimedia controller. In a third usage status, the multi-functional touchpad is connected with a charger stand, the multi-functional touchpad functions as a digital photo frame.

### FIELD OF THE INVENTION

The present invention relates to a computer keyboard, and more particularly to a computer keyboard has a multi-functional touchpad.

### BACKGROUND OF THE INVENTION

As known, a keyboard is a widely-used input device for inputting data (e.g. characters or numbers) to a computer system. FIG. 1A is a schematic view illustrating a conventional computer keyboard. As known, the conventional computer keyboard 1 comprises an ordinary keypad zone 10 and a numeric keypad zone 11. The ordinary keypad zone 10 comprises alphabetical keys, function keys and other keys, which are pressed to input characters, symbols or commands. The numeric keypad zone 11 comprises numeric keys 0˜9 and the “Enter” key. The numeric keypad zone 11 is usually used by accountants for successively inputting a great number of numerals.

For most non-accountants, since the numeric keypad zone 11 of the conventional keyboard is not frequently used, another computer keyboard 1′ is disclosed (see FIG. 1B). FIG. 1B is a schematic view illustrating another conventional computer keyboard. The computer keyboard 1′ has no numeric keypad zone 11. In this situation, the length of the computer keyboard is shorted, and the desk area occupied by the computer keyboard is reduced.

The computer keyboard 1′ with no numeric keypad zone 11, however, still has some drawbacks. For example, if the user wants to successively input a great number of numerals, the computer keyboard 1′ is not user-friendly.

Therefore, there is a need of providing a novel computer keyboard in order to enhance the flexibility of using the computer keyboard.

### SUMMARY OF THE INVENTION

The present invention provides a computer keyboard having a detachable multi-functional touchpad in order to enhance the flexibility of using the computer keyboard.

In accordance with an aspect of the present invention, there is provided a computer keyboard with a detachable multi-functional touchpad. The computer keyboard is in communication with a computer host. The computer keyboard includes a keyboard body and a multi-functional touchpad. The keyboard body has a first connecting part. A character, a numeral or a command is inputted to the computer host via the keyboard body. The multi-functional touchpad includes a display panel, a second connecting part and a micro-processing unit. The display panel is used for showing a first image or a second image. The second connecting part is selectively connected with or disconnected from the first connecting part of the keyboard body. A connection signal is generated when the second connecting part is connected with the first connecting part. A disconnection signal is generated when the second connecting part is disconnected from the first connecting part. The micro-processing unit is connected with the second connecting part for controlling the display panel to show the first image or the second image. In response to the connection signal, the micro-processing unit controls the display panel to show the first image. In response to the disconnection signal, the micro-processing unit controls the display panel to show the second image.

In an embodiment, the first image is an image of a numeric keypad, and the second image comprises plural multimedia control command icons. By touching one of the multimedia control command icons, a corresponding multimedia control command is generated.

In an embodiment, the multi-functional touchpad further includes a wireless transmitter for transmitting the multimedia control command to the computer host.

In an embodiment, the multi-functional touchpad further includes a memory card slot, and a memory card is inserted into the memory card slot.

In an embodiment, the computer keyboard further includes a charger stand. The charger stand is connected with the computer host. The charger stand includes a charger connecting part.

In an embodiment, when the second connecting part is connected with the charger connecting part of the charger stand, a charging signal is issued from the second connecting part. In response to the charging signal, the micro-processing unit controls the multi-functional touchpad to be charged and controls the display panel to show an image that is stored in the memory card.

In accordance with another aspect of the present invention, there is provided a computer keyboard with a detachable multi-functional touchpad. The computer keyboard is in communication with a computer host. The computer keyboard includes a keyboard body and a multi-functional touchpad. A character, a numeral or a command is inputted to the computer host via the keyboard body. The multi-functional touchpad includes a display panel, a panel mode selecting unit and a micro-processing unit. The display panel is used for showing a first image or a second image. The panel mode selecting unit is used for manually adjusting the multi-functional touchpad to be operated in a first operating mode or a second operating mode. The micro-processing unit is connected to the panel mode selecting unit. When the multi-functional touchpad is in the first operating mode, the micro-processing unit controls the display panel to show the first image. When the multi-functional touchpad is in the second operating mode, the micro-processing unit controls the display panel to show the second image.

In an embodiment, the keyboard body has a first connecting part, and the multi-functional touchpad has a second connecting part. When the multi-functional touchpad is combined with the keyboard body, the first connecting part and the second connecting part are connected with each other.

In an embodiment, the first image is an image of a numeric keypad, and the second image includes plural multimedia control command icons. By touching one of the multimedia control command icons, a corresponding multimedia control command is generated.

In an embodiment, the multi-functional touchpad further includes a wireless transmitter for transmitting the multimedia control command to the computer host.

In an embodiment, the multi-functional touchpad further includes a memory card slot, and a memory card is inserted into the memory card slot.

In an embodiment, the multi-functional touchpad is further adjusted to a third operating mode by the panel mode selecting unit.

In an embodiment, when the multi-functional touchpad is in the third operating mode, the micro-processing unit controls the display panel to show an image that is stored in the memory card.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic view illustrating a conventional computer keyboard;

FIG. 1B is a schematic view illustrating another conventional computer keyboard;

FIG. 2 is a schematic functional block diagram illustrating a computer keyboard according to a first embodiment of the present invention;

FIG. 3 is a schematic perspective view illustrating the computer keyboard according to the first embodiment of the present invention;

FIG. 4 is a schematic view illustrating the multi-functional touchpad of the computer keyboard in a first usage status according to the first embodiment of the present invention;

FIG. 5 is a schematic view illustrating the computer keyboard of the multi-functional touchpad in a second usage status according to the first embodiment of the present invention;

FIG. 6 is a schematic view illustrating the multi-functional touchpad of the computer keyboard in a third usage status according to the first embodiment of the present invention;

FIG. 7 is a schematic functional block diagram illustrating a computer keyboard according to a second embodiment of the present invention;

FIG. 8 is a schematic view illustrating the usage status of the multi-functional touchpad of the computer keyboard according to a second embodiment of the present invention, in which the multi-functional touchpad is in a first operating mode; and

FIG. 9 is a schematic perspective diagram illustrating another way of connecting the multi-functional touchpad with the keyboard body according to the present invention.

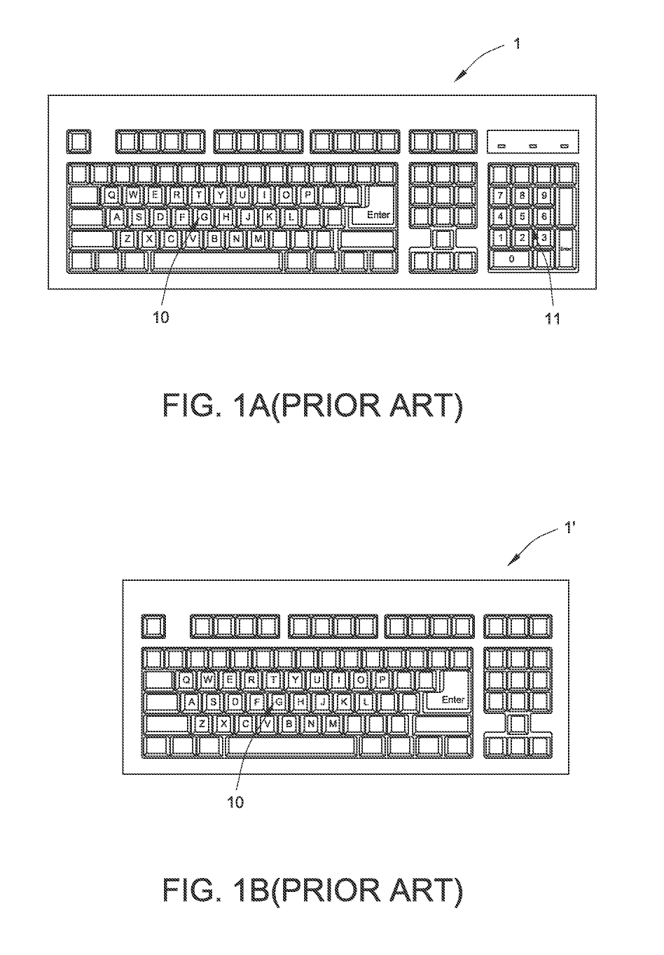

### DETAILED DESCRIPTION OF THE PREFERRED EMBODIMENT

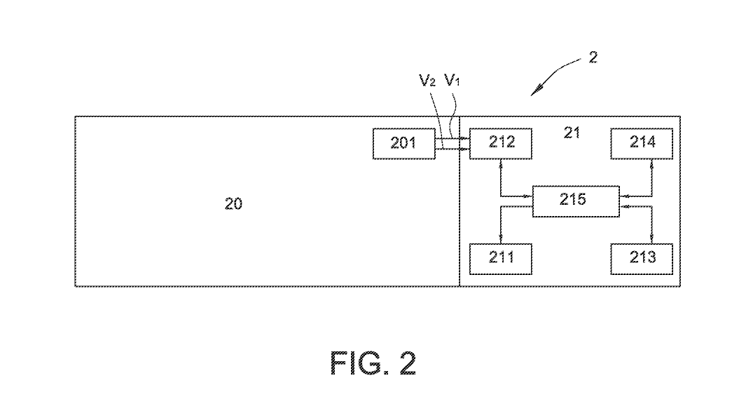

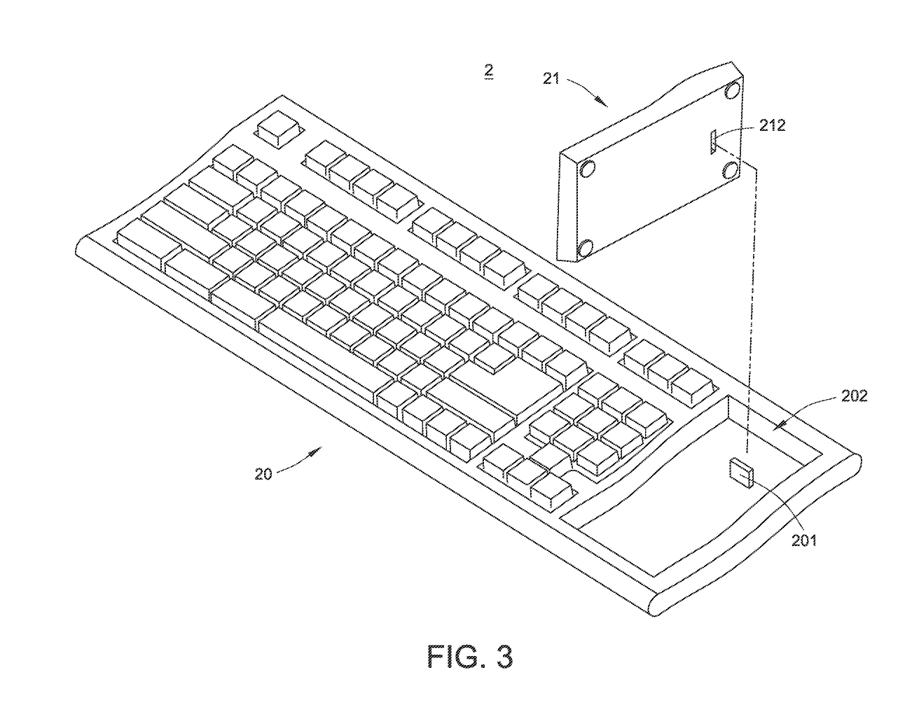

FIG. 2 is a schematic functional block diagram illustrating a computer keyboard according to a first embodiment of the present invention. FIG. 3 is a schematic perspective view illustrating the computer keyboard according to the first embodiment of the present invention. Please refer to FIGS. 2 and 3. The computer keyboard 2 comprises a keyboard body 20 and a multi-functional touchpad 21. The keyboard body 20 has a receptacle 202 for accommodating the multi-functional touchpad 21. A first connecting part 201 is disposed within the receptacle 202. The multi-functional touchpad 21 comprises a second connecting part 212, a display panel 211, a wireless transmitter 213 and a micro-processing unit 215. When the first connecting part 201 and the second connecting part 212 are connected with each other, a connection signal V₁ is generated by the second connecting part 212 and transmitted to the micro-processing unit 215. In response to the connection signal V₁, the micro-processing unit 215 controls the display panel 211 to show a first image. On the other hand, when the first connecting part 201 and the second connecting part 212 are disconnected from each other, a disconnection signal V₂ is generated by the second connecting part 212 and transmitted to the micro-processing unit 215. In response to the disconnection signal V₂, the micro-processing unit 215 controls the display panel 211 to show a second image. The multi-functional touchpad 21 further comprises a memory card slot 214. A memory card (not shown) may be inserted into the memory card slot 214.

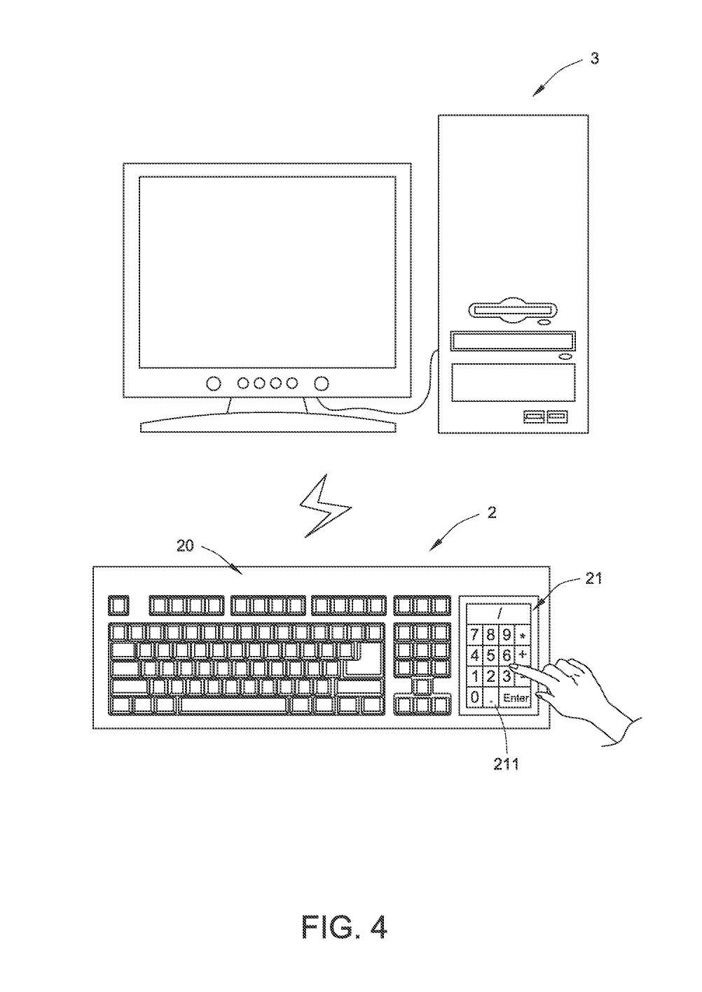

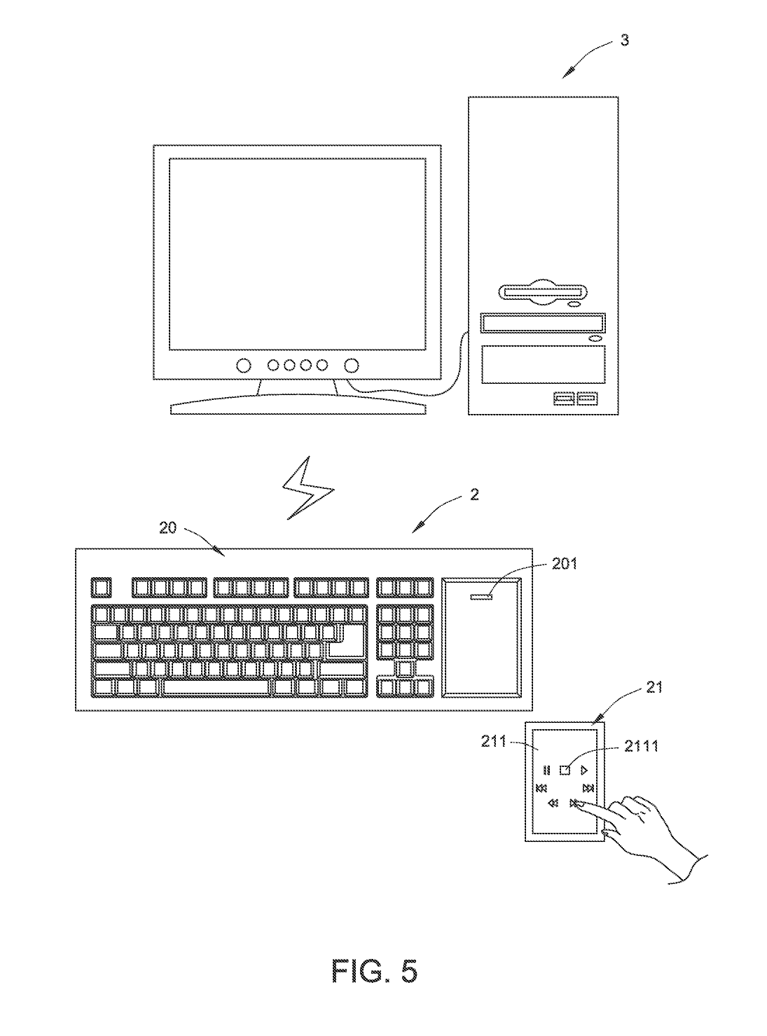

Hereinafter, the operations of the computer keyboard according to the first embodiment of the present invention will be illustrated with reference to FIGS. 4 and 5.

FIG. 4 is a schematic view illustrating the multi-functional touchpad of the computer keyboard in a first usage status according to the first embodiment of the present invention. When the multi-functional touchpad 21 is accommodated within the receptacle 202 of the keyboard body 20, the first connecting part 201 within the receptacle 202 is connected with the second connecting part 212 of the multi-functional touchpad 21. As such, a connection signal V₁ is generated by the second connecting part 212 and transmitted to the micro-processing unit 215. In response to the connection signal V₁, the micro-processing unit 215 controls the display panel 211 to show an image of a numeric keypad.

FIG. 5 is a schematic view illustrating the multi-functional touchpad of the computer keyboard in a second usage status according to the first embodiment of the present invention. When the multi-functional touchpad 21 is disconnected from the keyboard body 20, a disconnection signal V₂ is generated by the second connecting part 212 of the multi-functional touchpad 21 and transmitted to the micro-processing unit 215. In response to the disconnection signal V₂, the micro-processing unit 215 controls the multi-functional touchpad 21 to show a second image. The second image comprises the image of plural multimedia control command icons 2111. These multimedia control command icons 2111 include for example a playback command icon, a stop command icon, a previous page command icon, a next page command icon, a fast-forward command icon, a fast-backward command icon, or the like. In this situation, the multi-functional touchpad 21 may also be referred as a multimedia controller. By touching one of the multimedia control command icons 2111, a corresponding multimedia control command is generated. The multimedia control command is transmitted to the computer host 3 through the wireless transmitter 213, thereby controlling a multimedia playback program of the computer host 3.

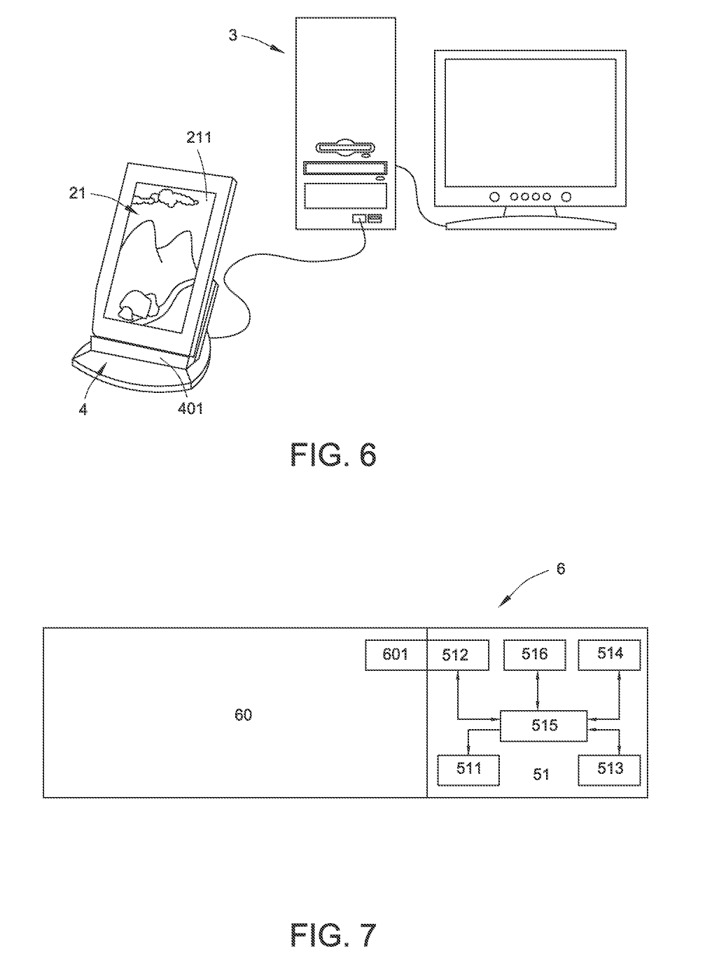

FIG. 6 is a schematic view illustrating the multi-functional touchpad of the computer keyboard in a third usage status according to the first embodiment of the present invention. In the third usage status of the multi-functional touchpad, the computer keyboard of the present invention further comprises a charger stand 4. The charger stand 4 is connected with the computer host 3. When the second connecting part 212 of the multi-functional touchpad 21 is connected with a charger connecting part 401 of the charger stand 4, a charging signal is generated by the second connecting part 212 and transmitted to the micro-processing unit 215. In response to the charging signal, the micro-processing unit 215 adjusts the multi-functional touchpad 21 to be charged. Meanwhile, the image predetermined by a memory card inserted in the memory card slot 214 is shown on the display panel 211. In this situation, the multi-functional touchpad 21 functions as a digital photo frame.

From the above discussions in the first embodiment, through the second connecting part 212, the multi-functional touchpad 21 of the present invention is able to automatically detect the usage status of the multi-functional touchpad 21. According to different usage statuses, the multi-functional touchpad 21 provides different functions. When the multi-functional touchpad 21 is connected with the keyboard body 20, the multi-functional touchpad 21 automatically displays the image of the numeric keypad. As such, the numeric keypad has the complete functions of a common numeric keypad. When the user does not want to use the function of the numeric keypad, the user may disconnect the multi-functional touchpad 21 from the keyboard body 20. In this situation, the multi-functional touchpad 21 functions as a multimedia controller. When the multi-functional touchpad 21 is connected with the charger stand 4 to be charged, the multi-functional touchpad 21 is made upright. In this situation, the multi-functional touchpad 21 functions as a digital photo frame. As a consequence, the digital photos are shown during the charging process.

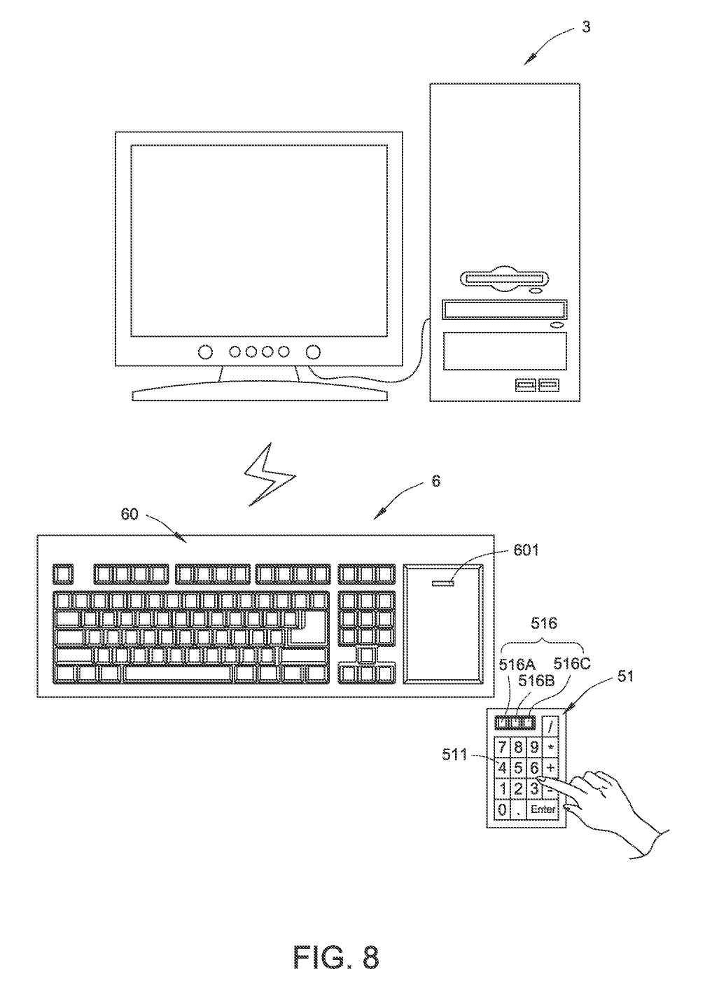

Moreover, a computer keyboard according to a second embodiment of the present invention will be illustrated with reference to FIGS. 7 and 8. FIG. 7 is a schematic functional block diagram illustrating a computer keyboard according to a second embodiment of the present invention. The computer keyboard 6 comprises a keyboard body 60 and a multi-functional touchpad 51. The keyboard body 60 comprises a first connecting part 601 to be electrically connected with the multi-functional touchpad 51. The multi-functional touchpad 51 comprises a second connecting part 512, a display panel 511, a wireless transmitter 513, a memory card slot 514, a micro-processing unit 515 and a panel mode selecting unit 516.

As previously described in the first embodiment, the function of the multi-functional touchpad 21 is automatically provided by using the first connecting part 201 of the multi-functional touchpad 21 to detect the electrical connection status of the multi-functional touchpad 21. Whereas, according to the second embodiment, through the panel mode selecting unit 516 of the multi-functional touchpad 51, the operating mode of the multi-functional touchpad 51 may be manually set by the user.

FIG. 8 is a schematic view illustrating the usage status of the multi-functional touchpad of the computer keyboard according to a second embodiment of the present invention, in which the multi-functional touchpad is in a first operating mode. In this embodiment, the panel mode selecting unit 516 comprises plural switches. For example, as shown in FIG. 8, the panel mode selecting unit 516 comprises three switches 516A, 516B and 516C. By pressing one of the switches of the panel mode selecting unit 516, the multi-functional touchpad 51 is selectively operated in a first operating mode, a second operating mode or a third operating mode. For example, as shown in FIG. 8, by pressing the switch 516A, the multi-functional touchpad 51 is operated in the first operating mode. In the first operating mode, an image of a numeric keypad is shown on the display panel 511 for providing the function of inputting numerals. Whereas, by pressing the switch 516B of the panel mode selecting unit 516, the multi-functional touchpad 51 is operated in the second operating mode. In the second operating mode, the images of the multimedia control command icons (see also FIG. 5) are shown on the display panel 511 of the multi-functional touchpad 51. In this situation, the multi-functional touchpad 51 functions as a multimedia controller. Whereas, by pressing the switch 516C of the panel mode selecting unit 516, the multi-functional touchpad 51 is operated in the third operating mode. In the third operating mode, the image stored in the memory card, which is inserted in the memory card slot 514, will be shown on the display panel 511 of the multi-functional touchpad 51. In this situation, the multi-functional touchpad 51 functions as a digital photo frame (see also FIG. 6).

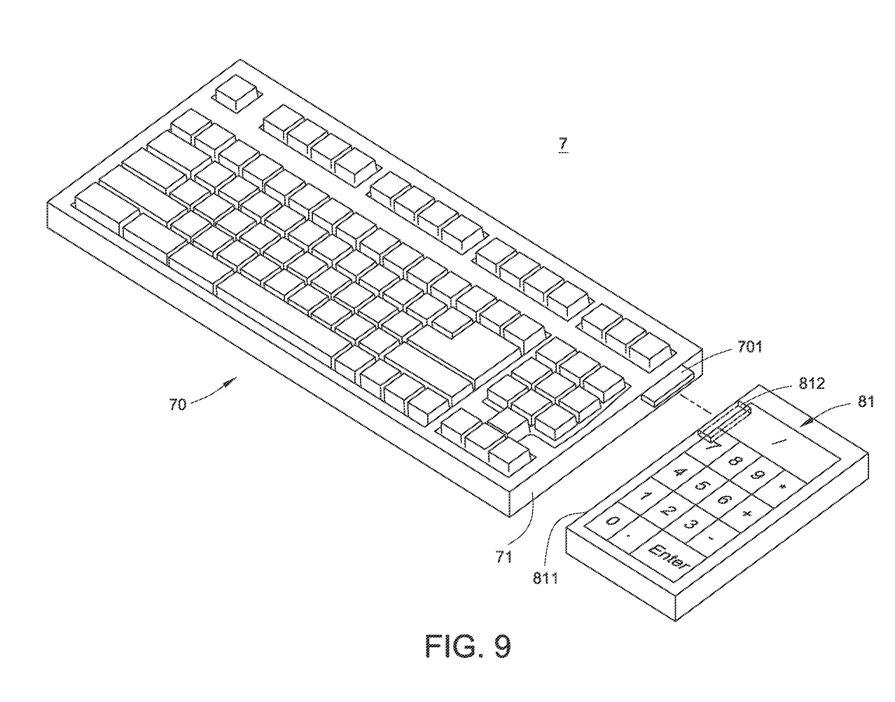

The way of connecting the multi-functional touchpad with the keyboard body according to the present invention is not limited to the way described in FIG. 3. Hereinafter, another way of connecting the multi-functional touchpad with the keyboard body will be illustrated with reference to FIG. 9. FIG. 9 is a schematic perspective diagram illustrating another way of connecting the multi-functional touchpad with the keyboard body according to the present invention. In comparison with FIG. 3, the keyboard body 70 of the computer keyboard 7 of FIG. 9 has no receptacle for accommodating the multi-functional touchpad 81. Whereas, the first connecting part 701 is disposed on a sidewall 71 of the keyboard body 70; and a second connecting part 812 is disposed on a sidewall 811 of the multi-functional touchpad 81. By moving the sidewall 811 of the multi-functional touchpad 81 toward the sidewall 71 of the keyboard body 70, the second connecting part 812 may be connected with the first connecting part 701. On the other hand, if the multi-functional touchpad 81 is detached from the keyboard body 70, the overall length of the computer keyboard 7 is shortened. As such, the space required for storing the computer keyboard 7 is reduced.

From the above description, the computer keyboard of the present invention comprises a keyboard body and a multi-functional touchpad. The multi-functional touchpad is selectively installed on the keyboard body or detached from the keyboard body. As such, the computer keyboard of the present invention may provide the function of the common numeric keypad as well as additional functions of the multi-functional touchpad. For the users who seldom use the numeric keypad zone, the flexibility of operating the computer keyboard is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer keyboard with a detachable multi-functional touchpad, said computer keyboard being in communication with a computer host, said computer keyboard comprising:
a keyboard body having a first connecting part, wherein a character, a numeral or a command is inputted to said computer host via said keyboard body; and
a multi-functional touchpad comprising:
a display panel for showing a first image or a second image;
a second connecting part selectively connected with or disconnected from said first connecting part of said keyboard body, wherein a connection signal is generated when said second connecting part is connected with said first connecting part, and a disconnection signal is generated when said second connecting part is disconnected from said first connecting part; and
a micro-processing unit connected with said second connecting part for controlling said display panel to show said first image or said second image, wherein in response to said connection signal, said micro-processing unit controls said display panel to show said first image, wherein in response to said disconnection signal, said micro-processing unit controls said display panel to show said second image.

2. The computer keyboard according to claim 1 wherein said first image is an image of a numeric keypad, and said second image comprises plural multimedia control command icons, wherein by touching one of said multimedia control command icons, a corresponding multimedia control command is generated.

3. The computer keyboard according to claim 2 wherein said multi-functional touchpad further comprises a wireless transmitter for transmitting said multimedia control command to said computer host.

4. The computer keyboard according to claim 1 wherein said multi-functional touchpad further comprises a memory card slot, and a memory card is inserted into said memory card slot.

5. The computer keyboard according to claim 4 wherein said computer keyboard further comprises a charger stand, wherein said charger stand is connected with said computer host, and said charger stand comprises a charger connecting part.

6. The computer keyboard according to claim 5 wherein when said second connecting part is connected with said charger connecting part of said charger stand, a charging signal is issued from said second connecting part, wherein in response to said charging signal, said micro-processing unit controls said multi-functional touchpad to be charged and controls said display panel to show an image that is stored in said memory card.

7. A computer keyboard with a detachable multi-functional touchpad, said computer keyboard being in communication with a computer host, said computer keyboard comprising:
a keyboard body, wherein a character, a numeral or a command is inputted to said computer host via said keyboard body; and
a multi-functional touchpad comprising:
a display panel for showing a first image or a second image;
a panel mode selecting unit for manually adjusting said multi-functional touchpad to be operated in a first operating mode or a second operating mode; and
a micro-processing unit connected to said panel mode selecting unit, wherein when said multi-functional touchpad is in said first operating mode, said micro-processing unit controls said display panel to show said first image, wherein when said multi-functional touchpad is in said second operating mode, said micro-processing unit controls said display panel to show said second image.

8. The computer keyboard according to claim 7 wherein said keyboard body has a first connecting part, and said multi-functional touchpad has a second connecting part, wherein when said multi-functional touchpad is combined with said keyboard body, said first connecting part and said second connecting part are connected with each other.

9. The computer keyboard according to claim 7 wherein said first image is an image of a numeric keypad, and said second image comprises plural multimedia control command icons, wherein by touching one of said multimedia control command icons, a corresponding multimedia control command is generated.

10. The computer keyboard according to claim 9 wherein said multi-functional touchpad further comprises a wireless transmitter for transmitting said multimedia control command to said computer host.

11. The computer keyboard according to claim 7 wherein said multi-functional touchpad further comprises a memory card slot, and a memory card is inserted into said memory card slot.

12. The computer keyboard according to claim 11 wherein said multi-functional touchpad is further adjusted to a third operating mode by said panel mode selecting unit.

13. The computer keyboard according to claim 12 wherein when said multi-functional touchpad is in said third operating mode, said micro-processing unit controls said display panel to show an image that is stored in said memory card.
